(19) United States
(12) Patent Application Publication
(10) Pub. No.: US 2017/0221141 A1
(43) Pub. Date: Aug. 3, 2017

(54) SYSTEM AND METHOD FOR LEASING DWELLINGS

(71) Applicant: LeaseKey IP, PLLC, Las Vagas, NV (US)

(72) Inventor: Keith W. Hatchett, Royal Palm Beach, FL (US)

(73) Assignee: LeaseKey IP, PLLC, Las Vagas, NV (US)

(21) Appl. No.: 15/486,304

(22) Filed: Apr. 13, 2017

Related U.S. Application Data
(63) Continuation-in-part of application No. 13/764,759, filed on Feb. 11, 2013, now abandoned.
Application No. 13/764,759 is a continuation-in-part of application No. 12/877,108, filed on Sep. 8, 2010, now abandoned.

(51) Int. Cl. G06Q 30/06; G06Q 40/02; G06Q 40/08

(52) U.S. Cl. CPC G06Q 30/0645; G06Q 40/08; G06Q 40/025

(57) ABSTRACT

A method and apparatus to lease a dwelling with a computer coupled to a network is disclosed. The method includes printing using a printer a deposit exemption policy and renter Insurance policy for a renter or resident of the dwelling backed by a third party in lieu of a security deposit and/or a last month rent for the dwelling. The policies are funded by the resident paying one-time pricing program fee equal to a portion of a first month's rent into an account. Funds are transferred from the account to pay one or more of the owner, the underwriter, sales and leasing agents, deposit exemption claims, credit score forbearance agreements, royalties and renters insurance.

### PRIORITY CLAIM

This application is a continuation-in-part of U.S. patent application Ser. No. 13/764,759 filed on Feb. 11, 2013, which is a continuation-in-part of U.S. patent application Ser. No. 12/877,108 filed on Sep. 8, 2010, the contents of which are hereby incorporated by reference.

### TECHNICAL FIELD

These claimed embodiments relate to a system and method for leasing a dwelling and more particularly a system and apparatus that efficiently increase the time to complete the leasing process that protects the leassor/owner and leasee/resident against loss.

### BACKGROUND OF THE INVENTION

A method and system for leasing a dwelling to a resident that protects the owner and resident against loss is disclosed.

Dwelling owners when renting their properties often require in advance first month's rent, a security deposit and a last month's rent to protect themselves in the event the renter defaults or causes damage to their property. As renters often have insufficient capital, it may be difficult for potential residents or future renters to obtain the necessary advance to rent the property. This situation frequently results in the potential resident not being able to rent the property or being forced to rent a less expensive property.

Also when the renter leases the property, unforeseen damages due to weather, fire or vandalism could be inflicted to the property. In addition, the renter may become unemployed. Consequently, the renter may have to vacate the property due to lack of funds to fix the property or inability to pay rent.

It is often the case that the renter may own multiple attached dwellings that receive fire or other damage. Further it may be difficult to locate the cause of the damage to determine liability. Thus when damage occurs multiple legal actions could occur to assess which resident is liable for the damage. Residents may have different insurance companies that are injected in the legal action. This legal action results in significant time and expense for the residents, owners and insurance companies.

### SUMMARY OF THE INVENTION

In one implementation, a method is disclosed for leasing one or more dwellings with a computer coupled to a network, the method includes receiving an input via the network from a first input device indicating resident identifying information and resident characteristic information related to a lease between the resident and the owner of a dwelling. A first input form is populated for display to a leasing agent on a first display device that receives resident identifying information and the lease characteristic information of a lease between the owner and the resident. Based on at least a portion of the lease characteristic information in the populated input form, a signal is sent via the network to initiate a transfer of funds from a bank account of the resident to a bank account of the owner for at least a first month's rent of the lease. The received lease identifying information and the lease characteristic information is stored via the network in one or more datastores. A second input is received via the network from a resident or leasing agent computer indicating the resident identifying information and insurance information. In response to receiving the second input, the lease characteristic information is retrieved from the datastore using the resident identifying information received from the second input device, and a second input form is at least partially populated for display on a second display device to a licensed agent (e.g. property and casualty insurance agent) of an insurance entity at least a portion of the received resident identifying information and the resident characteristic information.

In response to receiving the second input indicating the insurance information, the populating of the second input form is completed with the indicated insurance information. The lease characteristic information and insurance information in the populated second input form is stored in the datastore. Based on at least one of the resident characteristic information and insurance information in the populated second input form, a membership card and an insurance policy card containing the resident characteristic information is printed with a printer, and an indication is sent via the network to initiate a transfer funds from an account of the resident to an account of the leasing insurance entity of an amount equal to a portion of the amount of the first month's rent for a) a one-time pricing program fee, b) a membership fee, and c) one or more insurance policies, including a deposit exemption policy and a renters and/or residents casualty and property insurance policy for the resident and the owner. The policies will cover loss to the renter/owner of the dwelling/property in the event of at least one of a) damage to the at least one dwelling, and b) failure to pay future rent by the resident.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIGS. 1 and 2 are simplified schematic diagrams of a network and devices for leasing dwellings;

FIG. 3 is a flow chart for entering and assigning codes used by the leasing agent device shown in FIGS. 1 and 2;

FIG. 4 is a simplified diagram illustrating the distribution of funds for the one-time pricing program fee/membership fee/policy premium per from the LeasePal account shown in FIG. 2;

FIG. 5 is a simplified schematic diagram of a computing device shown in FIGS. 1 and 2.

FIG. 6a is a flow chart used by a leasing agent to lease dwellings using the system shown in FIGS. 1 and 2;

FIG. 6b is a flow chart used by an enrollment team, including a licensed insurance agent, to lease dwellings using the system shown in FIGS. 1 and 2;

FIG. 7 is a diagram illustrating the Policies/Cards printed by the printer shown in FIGS. 1 and 2; and

FIG. 8 is a simplified schematic diagram illustrating the benefits of the system shown in FIG. 1 and FIG. 2.

### DETAILED DESCRIPTION

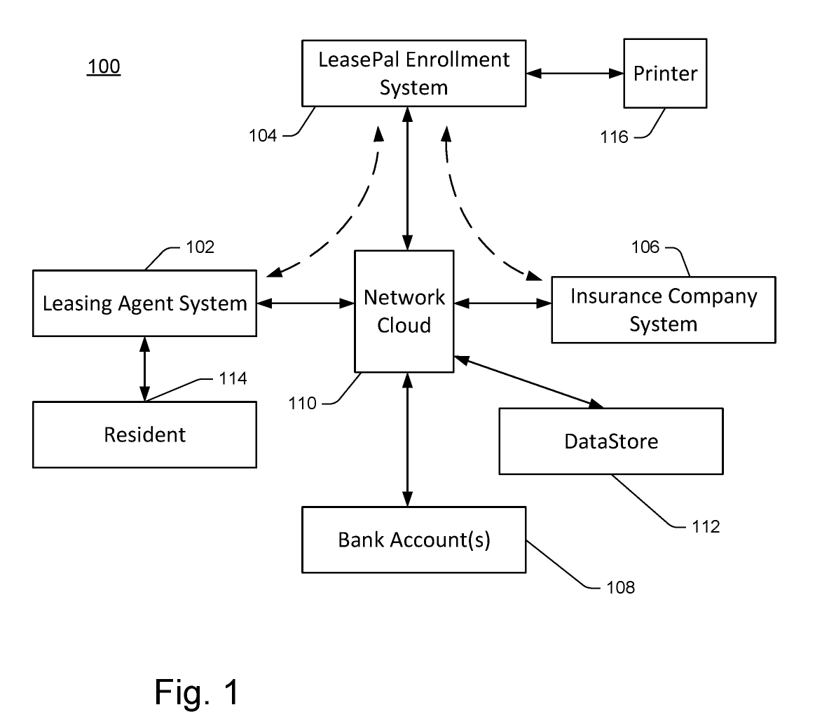

Referring to FIG. 1 there is shown a system 100 using a process for leasing one or more dwellings with one or more computers including leasing agent system 102, LeasePAL enrollment system 104 (Owned or controlled by a management entity, such as LeasePal Inc.), Insurance Company system 106, Banking systems 108 and data store 112 all coupled to a network cloud 110. Enrollment System 104 receives inputs via the network cloud 110 from a first input device such as leasing agent system 102 indicating resident identifying information and resident characteristic information for storage in data store 112. The resident identifying information and resident characteristic information are related to a lease between a resident 114 and an owner of at least one of the one or more dwellings. LeasePal Enrollment system 104 and Insurance company system 106 are coupled (either via a network or directly) to one or more printers 116. One or more printers 116 may include but is not limited to an inkjet printer, a laser printer, a photo printer, a matrix printer, networked printer, a wireless printer or wired printer or any device that prints on a physical media (including paper, transparency material, glossy material or plastic/polymer materials). LeasePal is an exemplary name of a management entity administering the leasing/insurance program. This entity may have any name and is not limited to one named “LeasePal”.

The resident identifying information and the lease characteristic information of a lease between the owner and the resident 114 is populated by a user (e.g. a leasing agent) of a leasing agent system 102 on a first input form for display to the user of the leasing agent system. Based on at least a portion of the lease characteristic information in the populated input form, a signal is sent via the network cloud 110 to initiate a transfer funds from an account of the resident 114 in the bank account system 107 to an account the owner for a first month's rent of the lease. The lease identifying information and the lease characteristic information received by the leasing agent system 102 is stored via the network cloud in one or more datastores 112.

A second input via the network cloud 110 is received by the LeasePal enrollment system 104 from the resident via the leasing agent system 102 for display to the user of the LeasePal enrollment system (e.g. a licensed insurance agent). The second input indicates the resident identifying information and insurance information.

In response to receiving the second input indicating the resident's 114 identifying information, the user of the LeasePAL enrollment system retrieves from the one or more datastores 112 the lease characteristic information using the resident identifying information received from the resident via the leasing agent system 102, and the LeasePal enrollment system at least partially populates on a second input form for display on a second display device to the user (e.g. a licensed insurance agent) of the LeasePal enrollment system at least a portion of the received resident identifying information and the resident characteristic information.

In response to receiving the second input from the Resident 114 indicating the insurance information, the populating of the second input form is populated by the user of the LeasePal enrollment system 104 with the indicated insurance information.

The lease characteristic information and insurance information in the populated second input form is transmitted by the LeasePal enrollment system for storage in at least one of the one or more datastores 112.

Based on at least one of the resident characteristic information and insurance information in the populated second input form, a signal is sent by the LeasePal enrollment system 104 and/or the insurance company system 106 to printer 116 to printer a membership card and an insurance policy card containing the resident characteristic information. A signal is also sent by the LeasePal enrollment system 104 and/or the insurance company system 106 via the network cloud 110 Bank Account system 108 to initiate a transfer funds from a bank account of the resident 114 to a LeasePal bank account of an amount equal to a portion of the amount of the Resident's first month's rent for a membership fee and a one-time pricing program fee to at least partially cover a) the cost of a deposit exemption policy, and b) an insurance policy for both the resident and the owner in the event of at least one of a loss due to damage to the dwelling the resident is renting, and failure to pay rent by the resident. Such one-time pricing program fee, membership fee and/or insurance policy premium may be paid in lieu of a security deposit and/or last month's rent payment the renter pays on entering of a domicile lease agreement.

Referring to FIG. 2, there is shown an alternate system diagram, to the one shown in FIG. 2, for a system 200 using a process for leasing one or more dwellings with one or more computers, including Leasing Agent Computer 202 coupled via a network 204 to LeasePal Enrollment team computer 206, Resident Bank account system 208, printer 210 and Data Store 212. Leasing agent computer 202 and LeasePal enrollment team are respectively coupled to printers 214 and 216.

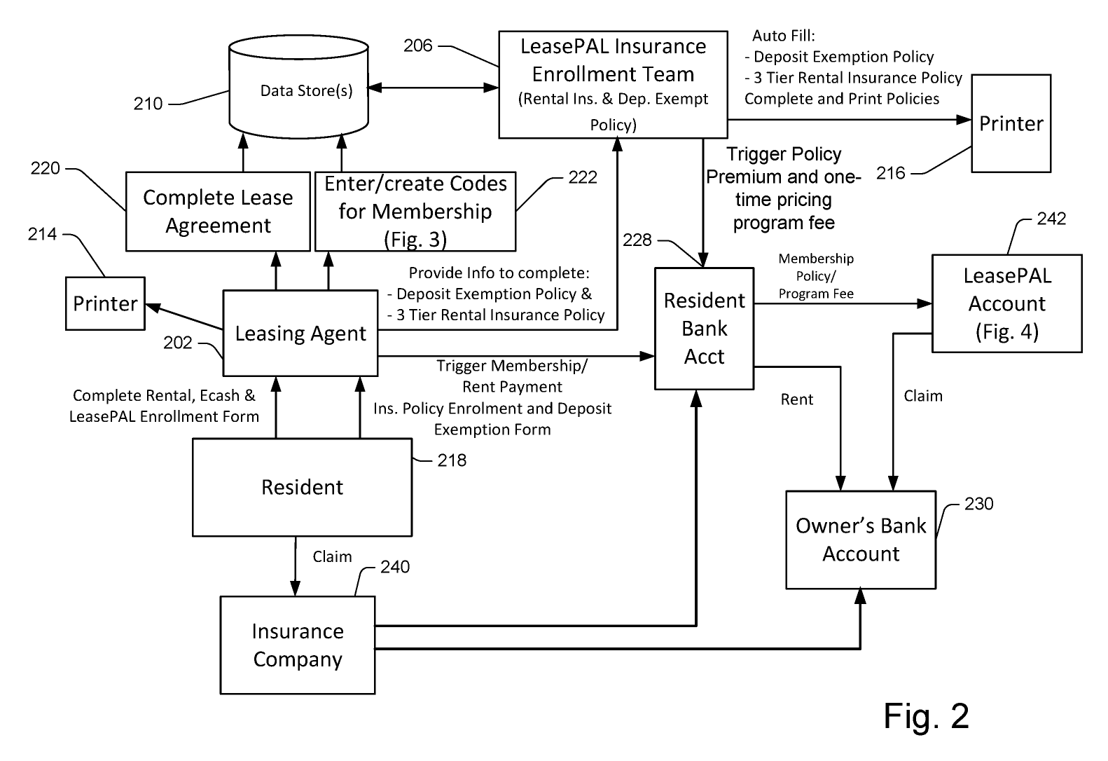

During the Enrollment process a resident 218 (future lease/renter) communicates with leasing agent operating a leasing agent computer 202. Leasing agent completes a lease agreement and enters/creates codes 222 as described in more detail in FIG. 3. The lease agreement may then be printed out using printer 214, and the codes 222 along with the lease agreement are stored in data store 212. The leasing agent may trigger the Resident's bank account via an electronic telecommunications network to trigger payment of a first month's rent and subsequent months' rent by transferring money from the resident's bank account 228 to the owner's bank account 230.

Subsequently to, or simultaneously with the resident 218 entering into a lease agreement, the resident, either alone or in combination with the leasing agent computer 202, contacts the LeasePal enrollment team 206 (including a license insurance agent). Upon contacting the team, codes are provided by the leasing agent and other characteristic information regarding the resident to the LeasePal enrollment team system 206. Upon receipt of this information/characteristics, the user (e.g. a licensed insurance agent) of computer 206 can retrieve additional information from datastore 212 to at least populate a deposit exemption policy form (to enroll the resident in the deposit exemption policy) and a three-tier rental insurance policy form (to enroll the resident in a 3-tier insurance policy) on the LeasePAL enrollment team computer 206. The user of the LeasePal enrollment computer 206, in combination with the resident completes additional information regarding the three-tier insurance policy.

In one implementation, the licensed insurance agent would enroll the resident in the deposit exemption policy and the 3-tier insurance policy annually for a fee to obtain for both policies. The deposit exemption policy would pay the owner of residence/dwelling for a period of time (typically 6 months) in the event the resident failed to pay rent. Information in the deposit exemption agreement derived from a) characteristic information of a potential resident of the dwelling received from the potential resident, and b) the location of the dwelling, the deposit exemption policy providing insurance backed by a third party to pay rent on behalf of a resident in the event the resident fails to pay rent. The credit score forbearance agreement may specify that the resident is without obligation to pay rent and has no penalty from the owner for a predetermined period of time in the event the resident fails to pay rent due to the resident being forced to vacate the dwelling on account of at least one of fire, water, wind, or environment disaster causing damage to the dwelling.

The three-tier insurance policy additional information may include: a) additional personal property limits, resident liability limits (min. limits may be preset by the resident or owner), involuntary unemployment coverage in terms of number of months' rent will be paid in the event of unemployment. Once the deposit exemption policy form and the three-tier insurance policy form is checked and completed, then an auto sign or an electric sign for each policy is completed by the resident 218. These policies may then be saved via the network to datastore, at which time the policy may be retrieved by an insurance company for approval. Upon approval, the LeasePal Enrollment team computer 206 sends the deposit exemption policy and the rental insurance policy to a printer, such as printer 216 for printing a physical copy.

It is noted, in one implementation of the system the deposit exemption policy is not optional. It should be noted that the resident may choose to enroll in an installment loan with LeasePal entity for payment of rent, and to pay their rent monthly though the installment loan process effectively making the rent payment a loan subject to reporting to a credit agency. The information in the loan agreement derived from at least a) characteristic information of a potential resident of the dwelling received from the potential resident, and b) the location of the dwelling. The loan agreement could specify a total amount of rent owed by the potential due to the owner of the dwelling over a predetermined period of time, a periodic monthly payment owed by the potential resident, and one or more dates of the periodic monthly payments

In one implementation, this loan agreement covers the gross of all 12 monthly payments for rent and consists of 12-monthly payments. The agreement allows the resident to send an electronic check (Echeck) via a payment processing company to the owner. There may be a nominal monthly fee added to the payment for the administrative cost of implementing such a program. This echeck system may allow the resident to pay their rent online through the click of a computer/mobile device button and the results of when the rent payments (and timely payments) were made could be reported by the servicing company to a credit reporting agency. Thus the residents credit score would be improved monthly upon timely payment of rent.

In another implementation, the installment loan could specify that resident is without obligation to pay on the loan and has no penalty from the owner or LeasePal entity for a predetermined period of time in the event the resident fails to pay rent due to the resident being forced to vacate the dwelling on account of at least one of fire, water, wind, or environment disaster causing damage to the dwelling

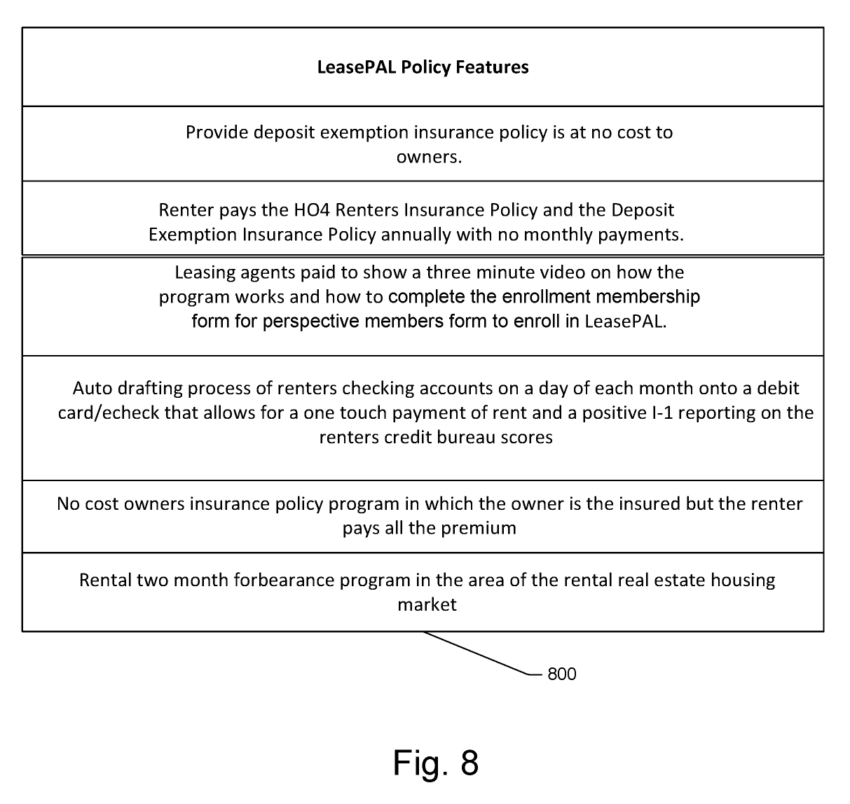

After the policies are approved, and membership fee paid the membership is complete, and the loan document is signed and approved, the insurance policies and cards are printed using a printer such as printer 216. In additional, an annual fee for membership may be debited from the Resident bank account 228, and the one-time pricing program fee may be debited from the Resident bank account 228 for the cost of the deposit exemption policy and the three-tier exemption policy and transferred to the LeasePal Account 242. The annual fee for the one-time pricing program fee may typically be around ½ of a month's rent and may be in lieu of a security deposit and/or last month's rent security. The policy and insurance card may also be electronically uploaded into a portal exclusively for use by the resident 218. In this manner, the resident may download or view their cards and their policy. FIG. 8 show exemplary cards that may be viewed and/or printed by the resident.

If the owner has a claim for unpaid rent, skips or evictions (under the deposit exemption policy), the owner would fill out a claim for submission to LeasePal, that would then be sent to its claims department for processing. LeasePal could then release funds from the LeasePal bank account 242 to the owner's bank account 230 to cover the loss.

In the event the resident 218 needs to make a claim for damages or loss, the resident 218 would fill out a claims form for transmission to the insurance company account 240 to obtain funds. Then insurance company could release funds on proof of damages/loss, from its bank account 240 to the resident's bank account 228 to cover the loss.

In the event the owner needs to make a claim for damages, the owner would fill out a claims form for transmission to the insurance company to obtain funds. Upon proof of damages/loss, the insurance company would credit the owner's bank account 230 to refund the owner's loss.

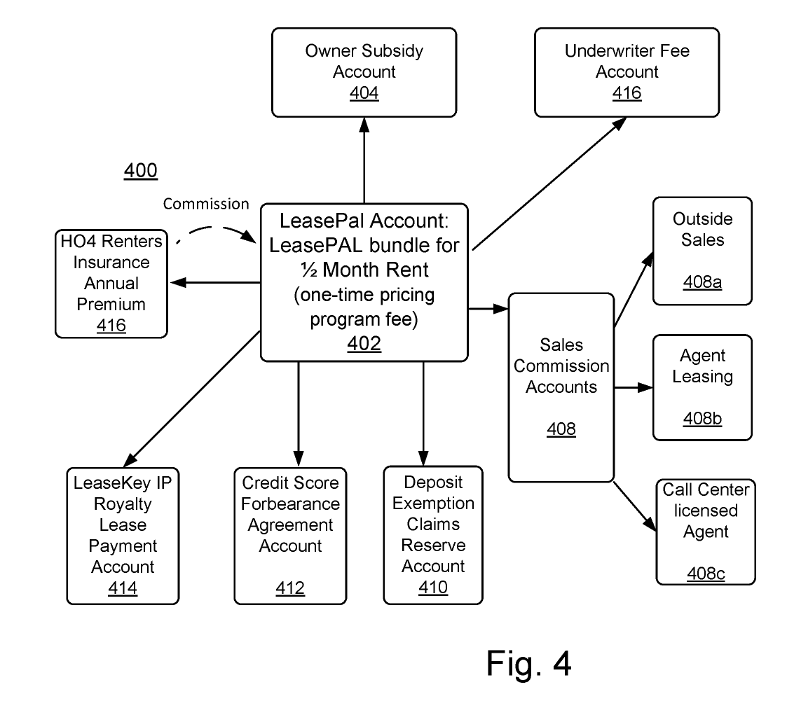

Illustrated in FIG. 3, is a process 300 for assigning/entering codes that relating to characteristics of the resident or resident's unit. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIGS. 2 and 5, although it may be implemented in other system architectures.

Referring to FIG. 3, a process 300 is shown including blocks 302-310 executed by leasing agent device 202. In block 302 the owners code is entered/assigned. In block 304, the property management code is entered, and in block 306 a location code is assigned. In block 307 a rental unit number code is entered and in block 310 a leasing agent code is assigned.

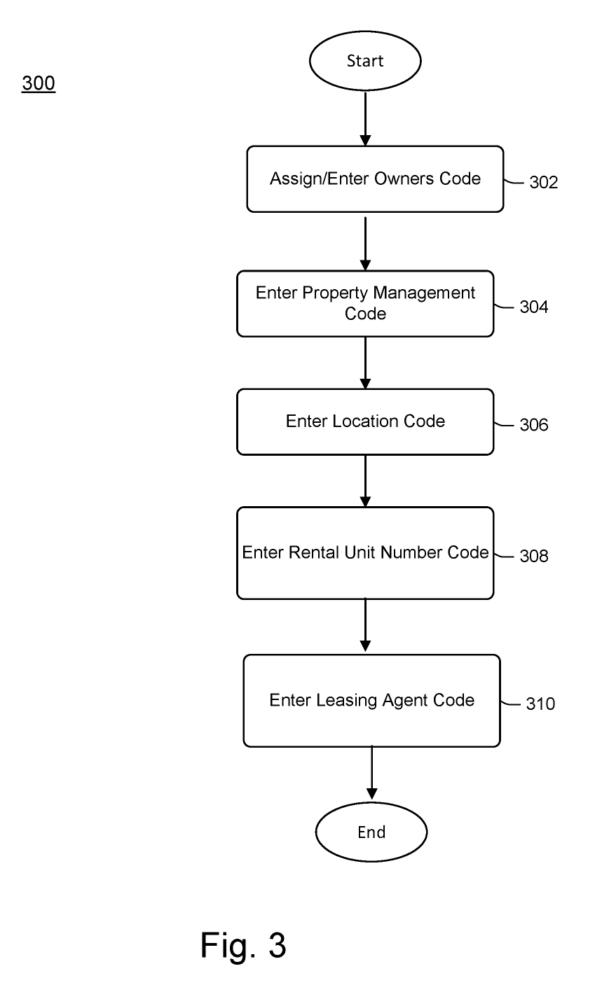

Referring to FIG. 4, is shown a diagram illustrating the distribution of funds for the annual payment (typically one time ½ months' rent pricing program fee) from the LeasePal account shown in FIG. 1b. The one-time pricing program fee, which is typically ½ of a month's rent is deposited into LeasePal account 402 for distribution to seven accounts 404-416. The leasing agent may collect an additional annual membership fee (typically 7.5% of the monthly rent) that is deposited into the LeasePal account 402.

In account 404, money is reserved for an owner subsidy that is paid back to the owner immediately upon resident enrolling and paying all fees. In account 406, an underwriting fee is paid. This fee is for administration of insurance (deposit exemption policy) and for obtaining a HO4 carrier or a carrier for an insurance captive.

In account 408, money is received into a sales commission account to pay an outside sales commission 408a, a leasing agent fee 408b, and pay a call center licensed agent account 408c. The leasing agents complete a showing of a video, collects payment for membership enrollment, apply codes into leasing agent (portal) for identification, and runs the computer to populate the policy forms to enroll residents into membership.

Call center licensed agents (e.g. a licensed insurance agent) complete insurance policy applications using the populated insurance applications forms, and completed installment loan agreements.

In account 410, money is received into a deposit exemption claims reserve account to pay for claims due to the renter failing to pay. The funds are typically held in the account for a predetermined period of time, typically 1 year lease agreement and then held in reserve for another year before being paid as profit to LeasePal.

In account 412, money is received into a credit score forbearance agreement account to cover administration costs. The forbearance agreement is a lease agreement and is not an insurance policy. In the event of a catastrophic condition, the resident will be provided money to pay rent while the residential unit is deemed uninhabitable. An agreement to protect the resident against legal action, collection activities, late fees and eviction for unpaid rent will provided if the unit is inhabitable and the lease agreement is kept. In one implementation, the next two rent payment are forbeared, the lease is then extended and the payments would then be added onto the end of the lease.

In account 414, a royalty will be paid to a third-party company for use of the intellectual property in implementing this system and use of the trademarks.

In account 416, the annual fee for the HO4 renter's insurance policy is paid. This policy is for a basic renter's policy, and additional fees for additional coverage may be paid monthly. In one implementation, a commission is provided to the LeasePal account upon the resident's annual payment of the HO4 renters insurance policy.

### Example Computing Device Architecture

In FIG. 2 there are illustrated selected modules in computing device 500 (computing devices of FIG. 1 or FIG. 2). Computing device 500 includes a processing device 504, memory 512, and display/input device 522. Processing device 504 may include a microprocessor, microcontroller or any such device for accessing memory 512 and display/input device 522. Processing device 504 has processing capabilities and memory suitable to store and execute computer-executable instructions. In one example, processing device 504 includes one or more processors.

Processing device 504 executes instructions stored in memory 512, and in response thereto, processes signals from and display/input device 522. Device 522 may include input device 526, network i/o device 528 that includes network and communication circuitry for communicating with a communications network (FIG. 1) and output device 529 for communicating with a printer. Input device 526 receives inputs from a user of the personal computing device and may include a keyboard, mouse, track pad, microphone, audio input device, video input device, or touch screen display. Display device 524 may include an LED, LCD, CRT or any type of display device.

Memory 512 may include a non-transitory volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium (including a non-transitory computer readable storage medium) which can be used to store the desired information and which can be accessed by a computer system.

Modules stored in memory 512 of the computing device 200 may include an operating system 514, an I/O controller 516, a library 518, an application 520 and a graphical user interface 522. Operating system 514 may be used by application 520 to operate device 500. I/O controller may provide drivers for device 500 to communicate with hardware 506 or device 508. Library 518 may include preconfigured parameters (or set by the user before or after initial operation) such as computing device operating parameters and configurations. Application 520 may include a generally known network browser (including, but not limited to, Internet Explorer, Netscape Firefox, Oracle, Chrome or Safari) for displaying web pages received from the network, a receiver 530, and account interface 532, a form filler and a storage interface 536 and other code for executing the processes shown or describe in connection with FIGS. 1-2, and FIGS. 6a and 6b.

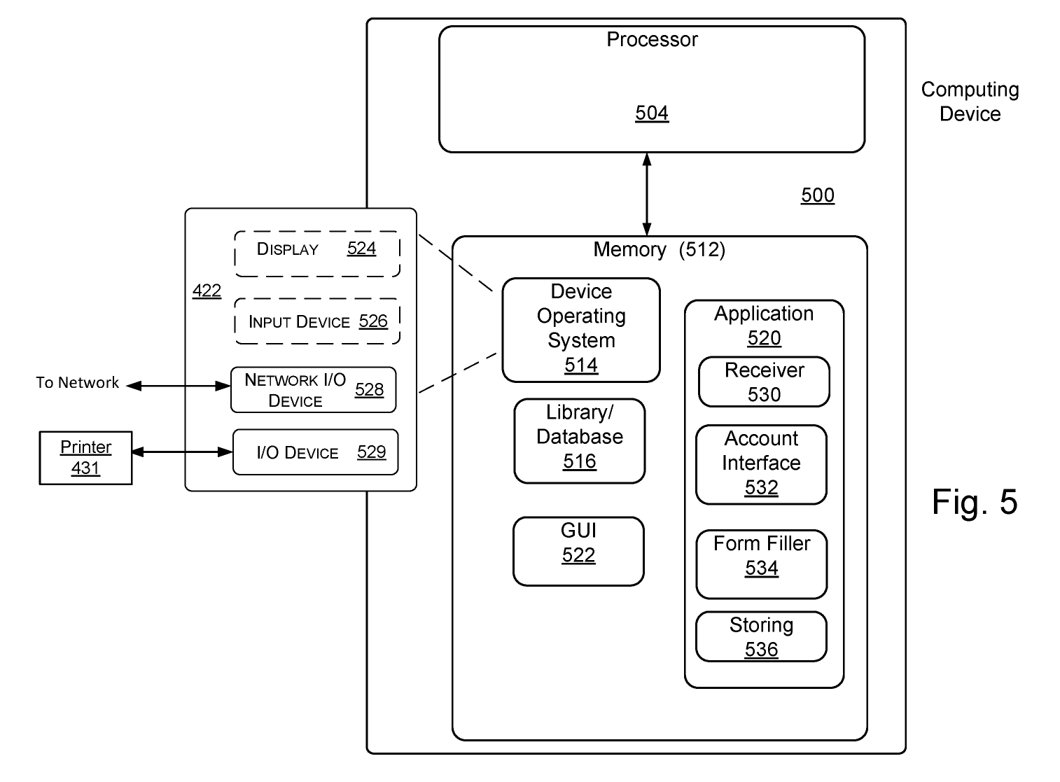

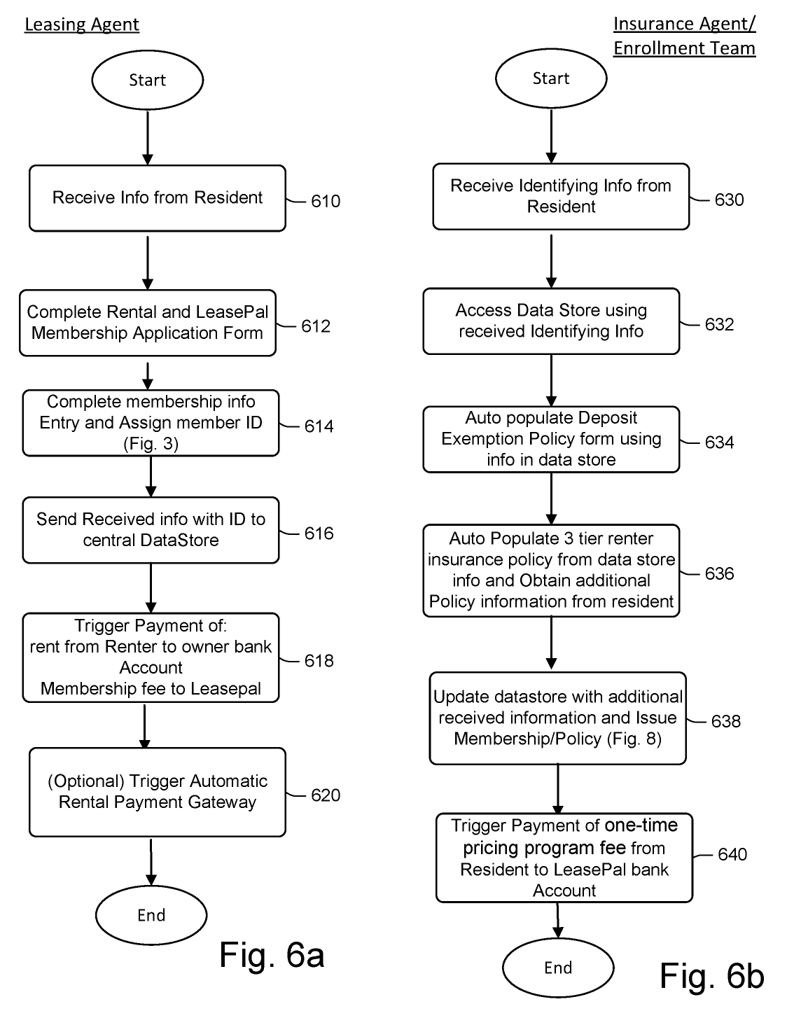

Illustrated in FIG. 6a-6b, is process 600 used by the leasing agent and licensed insurance agents in the enrollment team to enroll residents in the program. The exemplary process in FIGS. 6a-6b is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIGS. 2 and 5, although it may be implemented in other system architectures.

Referring to FIG. 6a, there is shown the process performed by a user of the leasing agent computer.

In block 610, information is received from the resident.

In block 612, the rental application form and LeasePal membership application form (to become an annual member) is completed.

In block 614, the complete membership information in entered and membership id is assigned as described in connection with FIG. 3.

In block 616, received information with identification is sent to the datastore.

In block 618, payment of rent and payment for membership is triggered from the renter's bank account to the owner's bank account. Optionally in block 620 such payment of rent may be triggered monthly (In lieu of an installment agreement).

Referring to FIG. 6b, there is shown the process performed by a user of the enrollment team computer.

In block 630, identifying information is received from the resident.

In block 632, the datastore is accessed by the user of the enrollment team computer using the received identifying information.

In block 634, the deposit exemption policy form is automatically populated using information from the data store.

In block 636, the three-tier renter's insurance policy form is automatically populated from datastore information, and the licensed insurance agent will obtain additional information from the resident to complete the insurance policy.

In block 638, the datastore is updated with the additional information so that a deposit exemption policy and renter's insurance policy is issued.

In block 640, payment of the insurance policy premiums and one-time pricing program fee is triggered to transfer payments from the Resident account to the LeasePAL bank account.

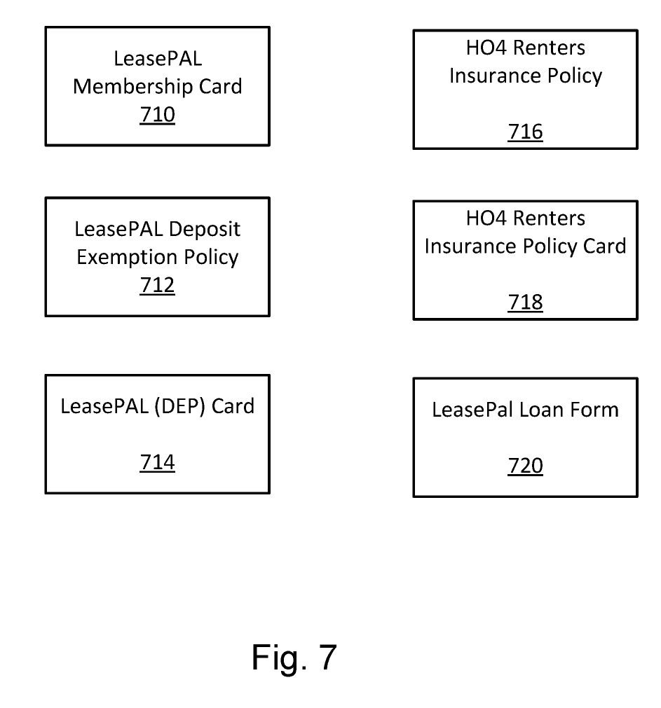

Referring to FIG. 7, there is shown the membership and policy information printed by printer 214 or 216. This information may be stored in data store and includes a LeasePAL membership card 710, a LeasePAL deposit exemption policy 712, a LeasePAL (Deposit exemption policy) card 714, and HO4 Renters insurance policy 716, an HO4 Insurance policy 718 and a LeasePal loan form 720.

Referring to FIG. 8, there is shown a diagram 800 of exemplary features and benefits implemented by the system described herein. These features include allowing in exchange for becoming a member of the program, paying a one-time pricing program fee of around ½ months' rent and in lieu of a security deposit and last month's rent upfront by the renter the following:
Provides deposit exemption insurance policy coverage at no cost to owners.
Renter pays the HO4 Renters Insurance Policy and the Deposit Exemption Insurance Policy annually with no monthly payments.
Leasing agents are paid to show a three-minute video on how the program works and to complete the enrollment membership form for perspective members form to enroll in LeasePal.
Auto drafting process of renters checking accounts on one day of each month, such as the 27th of each month, onto a debit card or using an electronic check using a servicing agent that allows for a one touch payment of rent and a positive I-1 reporting on the renter's credit bureau scores to a credit reporting agency.
No cost owner's insurance policy program in which the owner is the insured but the renter pays all the premium
Rental two-month forbearance program in the rental real estate housing market

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method for leasing one or more dwellings with a computer coupled to a network, the method comprising:
receiving an input via the network from a first input device indicating resident identifying information and resident characteristic information related to a lease between the resident and the owner of at least one of the one or more dwellings;
populating on a first input form for display to an owner on a first display device the received resident identifying information and the lease characteristic information of a lease between the owner and the resident;
based on at least a portion of the lease characteristic information in the populated input form, sending a signal via the network to initiate a transfer funds from an account of the resident to an account the owner for at least a first month's rent of the lease;
storing via the network the received lease identifying information and the lease characteristic information in one or more datastores;
receiving a second input via the network from a second input device indicating the resident identifying information and insurance information;
in response to receiving the second input from the second input device indicating the resident identifying information, a) retrieving from the one or more datastores the lease characteristic information using the resident identifying information received from the second input device, and b) at least partially populating on a second input form for display on a second display device to an agent of a leasing insurance entity at least a portion of the received resident identifying information and the resident characteristic information;
in response to receiving the second input from the second input device indicating the insurance information, completing the populating of the second input form with the indicated insurance information;
storing the lease characteristic information and insurance information in the populated second input form in at least one of the one or more datastores; and
based on at least one of the resident characteristic information and insurance information in the populated second input form, printing with a printer a membership card and an insurance policy card containing the resident characteristic information and sending an indication via the network to initiate a transfer of funds from an account of the resident to an account of the leasing insurance entity of an amount equal to a portion of the amount of the first month's rent for a one-time pricing program fee to cover a) a deposit exemption insurance policy for the resident and the owner in the event of a failure to pay future rent by the resident, and b) a renters insurance policy to cover property damage to the at least one dwelling.

2. The method as recited in claim 1, wherein the deposit exemption insurance policy is provided annually at no cost to the owner.

3. The method as recited in claim 1, wherein in response to a trigger from a LeasePAL computer, the bank account of the resident is automatically debited annually and credited to a LeasePAL bank account to pay for the renters Insurance Policy and the Deposit Exemption Insurance Policy.

4. The method as recited in claim 1 further comprising, automatically debiting the resident's bank account on the 27th of each month onto a credit card that allows for a one touch payment of rent from a mobile computing device and a positive reporting on the resident's credit bureau scores.

5. The method as recited in claim 1, further comprising generating a two-month forbearance program in the rental real estate housing market.

6. A system for leasing one or more dwellings with a computer coupled to a network, the system comprising:
a printing device for printing a physical copy of a deposit exemption agreement;
a first computing device in electrical communication with the printing device to send information to the printing device to print the deposit exemption agreement, the information in the deposit exemption agreement derived from a) characteristic information of a potential resident of the dwelling received from the potential resident, and b) the location of the dwelling, the deposit exemption policy providing insurance to pay rent on behalf of a resident in the event the resident fails to pay rent; and
a second computing device for triggering a bank account of the potential resident to transfer a one-time pricing program fee to a management account for the deposit exemption agreement, the amount of funds transferred set as a percentage of a month's rent specified in a monthly rental leasing agreement between the potential resident and an owner of the dwelling in lieu of the potential resident paying the owner a last month's rent for the dwelling and a security deposit.

7. The system as recited in claim 6, wherein the percentage is substantially half of the month's rent.

8. The system as recited in claim 6, further wherein the printer generates a credit score forbearance agreement that provides an assurance in which the resident is without obligation to pay rent and has no penalty from the owner for a predetermined period of time in the event the resident fails to pay rent due to the resident being forced to vacate the dwelling on account of at least one of fire, water, wind, or environment disaster causing damage to the dwelling.

9. A system for leasing one or more dwellings with one or more computing devices coupled to a network, the system comprising:
a printing device for printing a physical copy of a loan agreement between a potential resident and a management company;
a first of the one or more computing devices electrically coupled with the printing device for sending information to the printing device to print the loan agreement, the information in the loan agreement derived from a) characteristic information of a potential resident of the dwelling received from the potential resident, and b) the location of the dwelling, the loan agreement specifying a total amount of rent owed by the potential resident due to the owner of the dwelling over a predetermined period of time, a periodic monthly payment owed by the potential resident, and one or more dates of the periodic monthly payments; and
a second of the one or more computing devices for triggering via the network a bank account of the potential resident to transfer funds to the management account on one or more dates set in the loan agreement for payment to the owner of the residence; and
a third of the one or more computing devices, in response to triggering of the bank account, to send timeliness information via the network to a credit reporting agency computer indicating timeliness of payments made by the potential resident pursuant to the loan agreement.

10. The system as recited in claim 9, wherein the information in the loan agreement is derived using the second of the one or more computing devices.

11. The system as recited in claim 9, wherein the printer is at least one of an inkjet printer, a laser printer, a photo printer, a matrix printer, networked printer, a wireless printer or wired printer.

12. The system as recited in claim 11, wherein the printer prints a manifestation of the loan agreement on a physical media including at least one of paper, transparency material, glossy material, plastic material or polymer material.
